(19) United States
(12) Patent Application Publication
(10) Pub. No.: US 2006/0096404 A1
(43) Pub. Date: May 11, 2006

(54) BICYCLE SHIFTER

(75) Inventors: Robert Wessel, Regensburg (DE); Scott McLaughlin, Schweinfurt (DE); Martin Weiss, Schweinfurt (DE); Robert Boehm, Mainberg (DE); Markus Riehl, Schweinfurt (DE)

Correspondence Address: SRAM CORPORATION, 1333 N. KINGSBURY, 4TH FLOOR, CHICAGO, IL, 60622, US

(73) Assignee: SRAM DEUTSCHLAND GMBH, Schweinfurt (DE)

(21) Appl. No.: 11/163,503

(22) Filed: Oct. 20, 2005

(30) Foreign Application Priority Data
Oct. 26, 2004 (DE) 10 2004 051 883.1

(51) Int. Cl. F16C 1/12

(52) U.S. Cl. 74/501.6

(57) ABSTRACT

The invention relates to a trigger shifter with virtually no takeup distance during the takeup process. In its original position, the takeup pawl is located in the immediate vicinity of the transport tooth set, such that the takeup pawl and takeup lever do not need to cover a takeup distance. In the release process, the takeup pawl, which is in the ready position to engage, is moved out of the region of the transport tooth set by means of a connecting link, preferably a shackle spring, and subsequently the retaining pawl is disengaged so that so that the cable coil can be rotated by the prestressed cable pull without any obstacles. In addition to its function of controlling the takeup pawl, the shackle spring can also provide initial tension in the retaining direction to the sliding element with the retaining pawl.

The present invention relates to a shifting mechanism for a stepping shifter with a takeup, retaining, and release mechanism, in particular a cable retraction and positioning device for takeup, retaining, and releasing the cable pull according to the generic portion of the principal claim. This cable retraction and positioning device has its application in trigger shifters for activating manually shifted transmissions on bicycles. These trigger shifters may be embodied as rotary grip shifters or lever shifters with a single lever for the release and takeup processes or with separate takeup and release levers.

Stepping shifters are used for the takeup and release of the spring-loaded cable pull and return to their initial position after their activation or after the shifting process has been initiated. Stepping or trigger shifters are known from German Patent No. 102 13 450 A1 and German Patent No. 102 24 196 A1.

German Patent No. 102 13 450 discloses the release mechanism of a trigger shifter that requires very few raw components. The release lever and its extension rest against the blocking element in their original position; the blocking element fixes the spring-loaded cable coil in its position and moves the blocking element out of the blocking tooth region during the release process. This arrangement allows an immediate mediate conversion of the shifting motion of the release lever into a release motion of the blocking element that is engaged in the blocking tooth set. An equally direct arrangement of the takeup pawl on the transport tooth set can also accelerate the takeup process if the movement of the takeup lever is converted immediately into a rotational movement of the cable coil by direct engagement in the transport tooth set.

The trigger shifter disclosed in German Patent No. 102 24 196 contains two shifting levers, one for takeup or winding of the cable pull and one for disengaging the positioning and retaining device and for releasing the cable pull.

The cable coil is prestressed in the unwinding direction by a return spring acting on the cable pull and is non-rotatably joined to a disk element that is fitted with three tooth segments. The cable coil is rotated into or held at the desired gear ratio by the disk element. Two tooth segments are located on the perimeter of the disk element. The third tooth segment is arranged in an opening in the disk element and has a tooth set that points inwards in whose saw teeth the takeup pawl engages during the takeup process in order to gradually wind up the cable pull. The takeup pawl is held in its disengaged original position by a pawl spring and is mounted in the activation lever. It pivots around a pawl axis that runs approximately perpendicular or, preferably, parallel to the central axis of the cable coil. Because the activation lever is arranged ranged below the supporting plate and the sliding element with the takeup tooth segment is arranged thereabove, the takeup pawl reaches through the supporting plate and engages with the corresponding tooth set during the takeup process.

The takeup process is initiated by the activation lever, which rotates against a return spring around the central axis. Depending on the pivot angle of the activation lever, the shifting system is shifted by one or more shifting steps. If the activation lever is released again, the lever and takeup pawl return to their original position with the aid of the spring. After the takeup process has been completed, the cable coil is retained in its current shift setting by a retaining pawl that is also spring-loaded and that engages in a tooth segment on the perimeter of the disk element.

In the release process, the release lever, which is fitted with a return spring, is activated and pushes against the sliding element, which is prestressed in the direction of the retaining tooth set and designed with two fixed pawls. The retaining pawl, which is engaged, is pushed out of the saw-tooth contour of the first tooth segment on the perimeter of the disk element. The retaining pawl and catch pawl are located across from one another and are attached in a fixed manner to the sliding element fitted around the disk element. The cable coil rotates in the unwinding direction until the catch pawl engaged in the tooth contour of the second tooth segment rests against the next tooth and interrupts the unwinding movement. If the release lever is unloaded, it is then able to return to its original position, whereupon the sliding element is moved back into its retaining position. The catch pawl is moved out of the tooth contour of the second tooth segment and the cable coil rotates farther in the unwinding direction. The retreating catch pawl follows the retaining pawl and then engages again in the tooth contour of the first tooth segment. The unwinding movement is stopped again by the retaining pawl resting against the next saw tooth,and the current gear ratio is fixed.

These trigger shifters are distinguished by their good function and precise shifting processes. However, there is still potential to improve and increase the shifting speed, in particular during the winding process. As in most current trigger shifters, during the takeup process, the activation lever must first cover a takeup distance before the takeup pawl engages in the transport tooth set and initiates the shifting motion.

Based on this prior art, the object of the invention is to create a trigger shifter that converts the shifting motion of the takeup element almost immediately into a takeup movement of the cable coil.

As in the presented prior art, the activation or takeup lever rotates the winding coil by way of a takeup pawl that simultaneously engages in a transport tooth set. In its original position, the takeup pawl is kept out of engagement by a pawl spring or a displacement mechanism so that the takeup lever must first perform a pivoting motion in order to bring the takeup pawl into engagement at the corresponding transport tooth, even before a takeup movement can occur on the cable coil.

In order to realize a rapid takeup function, it is necessary at the beginning of the takeup process for the takeup pawl to be in the closest possible vicinity of the transport tooth set or to be already engaged there.

This objective is attained according to the characterizing portions of the claims, substantially by a takeup pawl that is almost engaged while in its original position. Upon the activation of the release element, for example, a release lever or a rotary grip, this takeup pawl is moved either directly or indirectly out of the region of the transport tooth set even before the retaining pawl has been moved out of the retaining tooth set.

Fundamentally, the takeup pawl is engaged with the transport tooth set when recovering the cable pull and must be securely disengaged during the release process. However, when the shifter is not activated, in contrast to the teaching of German Patent No. 102 24 196 Al, the takeup pawl is not resting unloaded against the corresponding transport tooth or located in the engagement setting or in the immediate region of the transport tooth set. During the takeup process or when the takeup element, for example, a takeup lever or a rotary grip, has been activated, the cable pull is immediately recovered. In its original or starting position, the takeup lever is pressed against a stop by means of loaded spring. The takeup pawl is mounted in the takeup lever and pivots around a pawl axis that runs approximately perpendicular or, preferably, parallel to the central axis of the cable pull. The takeup pawl is prestressed by means of a pawl spring in the direction of the transport tooth set. Thus, the takeup pawl is constantly engaged on the transport tooth set in its original position. Because the takeup pawl is mounted in the takeup lever, it is possible to define the position of the takeup pawl relative to the transport tooth set using the position of the takeup lever, which is adjacent to a stop in its original position. The original position of the takeup lever is selected in such a way that, although the takeup pawl is engaged in the transport tooth set, it hardly touches the transport tooth set at all or rests against it without a load. In order for the takeup pawl not to interfere with the release process in this engagement position, the takeup pawl must pivot out of the region of the transport tooth set immediately upon the initiation of the release process. This causes a decoupling of the takeup lever and takeup pawl opposite the takeup direction because the takeup lever rests against a stop in its original position and thus can no longer be deflected in this direction or opposite the takeup direction. Upon initiation of the release process, the takeup pawl located in the engagement position is moved out of the tooth region of the transport tooth set directly by the release lever, in a manner similar to that recited in German Patent No. 102 13 450, or indirectly by way of a connecting link, preferably a spring element. The takeup pawl must pivot out of the region of the transport tooth set even before a movement of the cable coil in the release direction because it will otherwise be clamped into this engagement due to the initial tension of the cable pull. This process may be controlled by path or speed, such that the activation path of the release lever required to open the takeup pawl is shorter than the path required for opening the retaining pawl or, after activation of the release lever, the release pawl must open at a greater speed than the retaining pawl. It is particularly easy to achieve timely opening and/or pivoting away by the takeup pawl using a springy connecting link in that the connecting link is substantially harder than the initial tension spring of the takeup pawl acting in the engagement direction. Upon activation of the release lever, the springy connecting link is first moved against the takeup pawl and pushes it out of the region of the transport tooth set against a stop, the connecting link is subsequently pushed farther against the retaining pawl and moves the pawl out of its retaining position on the disk element. This allows the release of the spring-loaded cable pull. The arrangement of the elastic or springy connecting link between the release lever and the takeup pawl or between the sliding element with the retaining and catch pawl and the takeup pawl ensures good shifting function even in the case of cruder production tolerances.

In a preferred embodiment of the invention, the connecting link is embodied as a shackle spring, with one end being supported on the housing or the supporting plate and the other end being connected directly to the release lever or to the sliding element. Upon the activation of the release lever, it moves the sliding element against the initial tension of the shackle spring, which pivots around the end supported on the supporting plate and moves the takeup pawl, with the shackle, out of its engagement position even before the retaining pawl releases the prestressed disk element. The shackle spring, which is under initial tension, serves not only to steer the takeup pawl forcibly out of the region of the transport tooth set on the disk element, but also aids or guides the return process of the sliding element or release lever.

### BRIEF DESCRIPTION OF THE DRAWINGS

The present invention will be described in detail with reference to the attached drawings; these drawings are to be viewed only as a non-limiting example.

FIG. 1 shows a trigger shifter with an opened housing cover in the rest position.

FIG. 2 shows a trigger shifter with an opened housing cover during the takeup process.

FIG. 3 shows a trigger shifter with an opened housing cover during the release process.

FIG. 4 shows an exploded depiction of the trigger shifter.

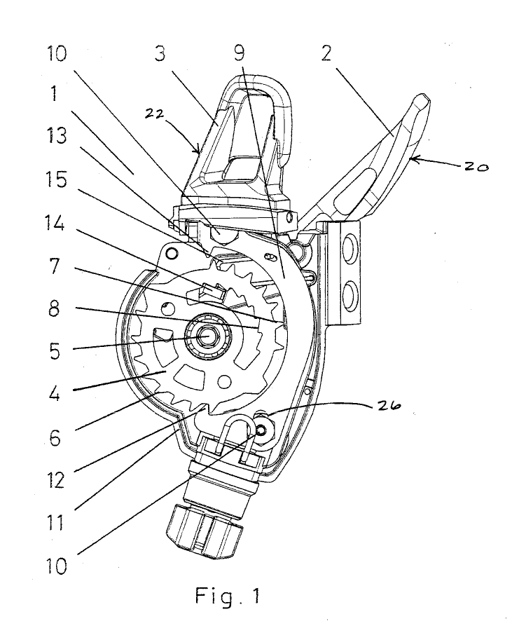

FIG. 1 shows an opened trigger shifter 1 with a takeup element in the form of a takeup lever 2 and a release element in the form of a release lever 3, both in the rest position. The disk element 4 is mounted on the central axis 5 and non-rotatably joined to the cable coil. The disk element 4 is provided with a retaining tooth set 6, a catch tooth set 7, and a transport tooth set 8. Upon activation, the release lever 3 acts on the sliding element 9, which allows an unwinding movement of the cable pull. The sliding element 9 is held by guide elements.10 that are anchored in the shifter housing 11. The retaining pawl 12 and catch pawl 13 are arranged on the sliding element 9; upon activation, these pawls alternately engage the corresponding tooth set on the disk element 4. In its rest position, the retaining pawl 12 engages in the retaining tooth set 6 and fixes the disk element 4 in position, which would otherwise rotate in the unwinding direction due to the initial tension acting on the cable coil and the cable pull. The takeup pawl 14 is in its ready position in the region of the transport tooth set 8 in order to be able to transfer the lever movement onto the disk element immediately upon the initiation of the takeup process. The connecting link in the form of a spring or shackle spring 15 is supported on one side on the shifter housing 11 and is connected on the other side to the sliding element 9. The shackle spring 15 is arranged in such a way that the shackle is located in the direct vicinity of the takeup pawl 14, which it moves out of the transport tooth set 8 upon the initiation of the release process. Before the retaining pawl 12 releases the corresponding retaining tooth, the takeup pawl 14 must have been pushed out of the transport tooth set by the shackle spring 15 because otherwise the takeup pawl 14 blocks the unwinding process. During the takeup process, the takeup pawl transfers the movement of the takeup lever onto the disk element. Thus the sliding element 9 is pushed along the back of the nearest retaining tooth by the movement of the slanted back of the retaining pawl 12. The shackle spring attached to the sliding element is moved as well. However, it does not come into contact with the takeup pawl because the takeup pawl has already rotated the disk element farther in the winding direction and has thus assumed a new position.

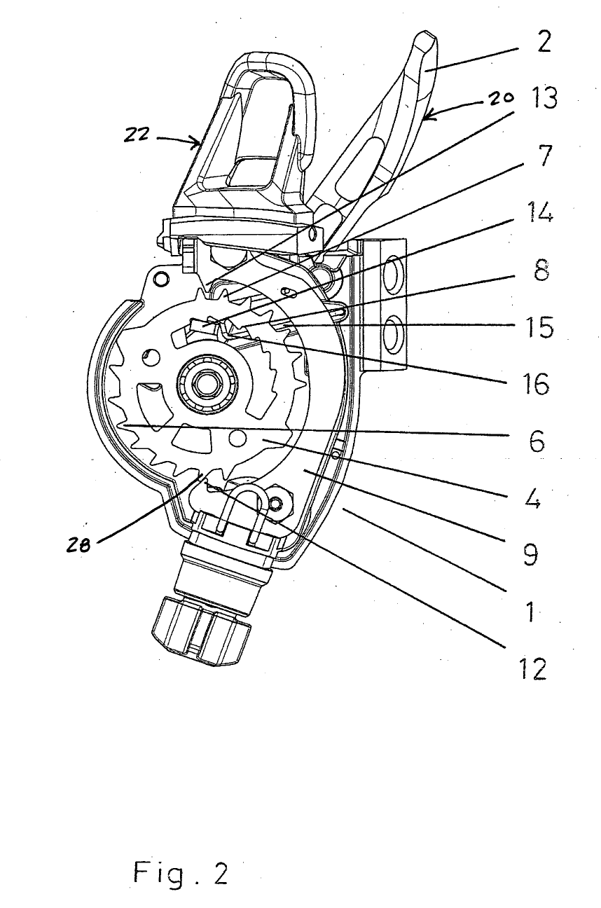

FIG. 2 shows the trigger shifter 1 with an opened housing cover during the takeup process. The takeup lever 2 has already moved the takeup pawl 14, which is engaged in the transport tooth set 8, in the winding direction. In so doing, the sliding element 9, along with the retaining pawl 12, is slid over the rear of the corresponding tooth of the retaining tooth set 6. The shackle 16 of the shackle spring 15, which is attached at one end to the sliding element 9, also performs a pivoting motion during the takeup process, whereupon it arrives in the position of the takeup pawl 14 that the takeup pawl assumes in the rest position. If the takeup process is continued, the retaining pawl 12 of the spring-loaded sliding element 9 will spring over the tooth tip of the retaining tooth into the next tooth hole of the retaining tooth set 6 and prevent any backward motion by the disk element 4 when the takeup lever 2 and takeup pawl 14 return to their initial position after the shifting process.

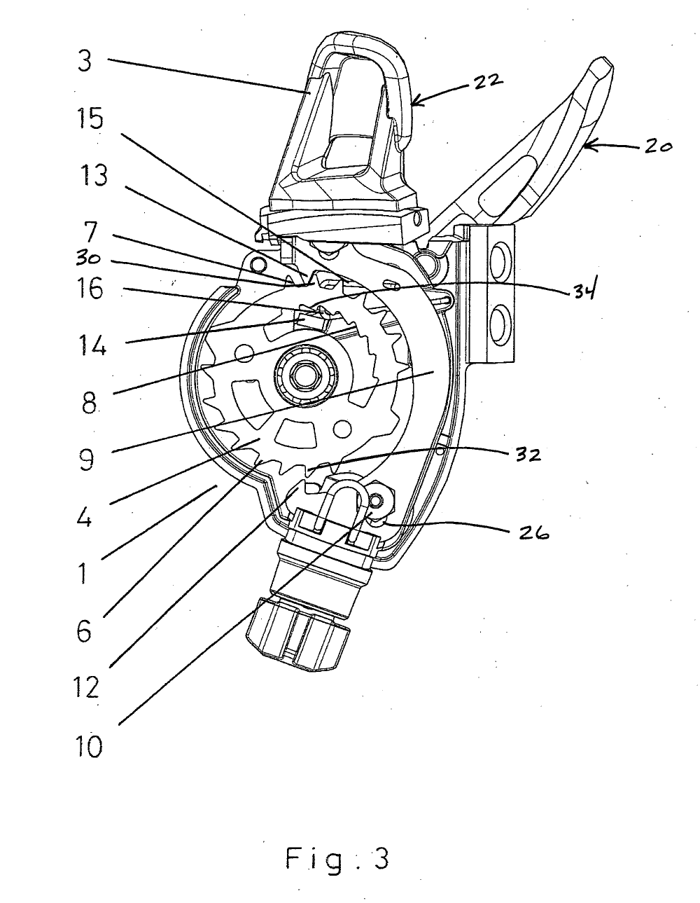

FIG. 3 shows a trigger shifter 1 during the release process. When the release lever 3 is activated, the sliding element 9 with the engaged retaining pawl 12 is pushed out of the rest position along the guide element 10. In so doing, the takeup pawl 14 engaged in the transport tooth set 8 is brought out of engagement by the shackle spring 15 before the retaining pawl 12 releases the disk element 4. In order to ensure that the cable coil and/or disk element 12 does not continue to rotate uncontrollably, the catch pawl 13 engages in the catch tooth set 7 and thus, in contrast to a multi-stage shifting process, allows only one defined single-stage shifting process during the takeup process. When the release lever 3 has returned to its original position, the retaining pawl 12 first engages in the retaining tooth set 6 and takes over the fixation of the disk element 4 before the takeup pawl 14 returns to its ready position in the region of the transport tooth set 8.

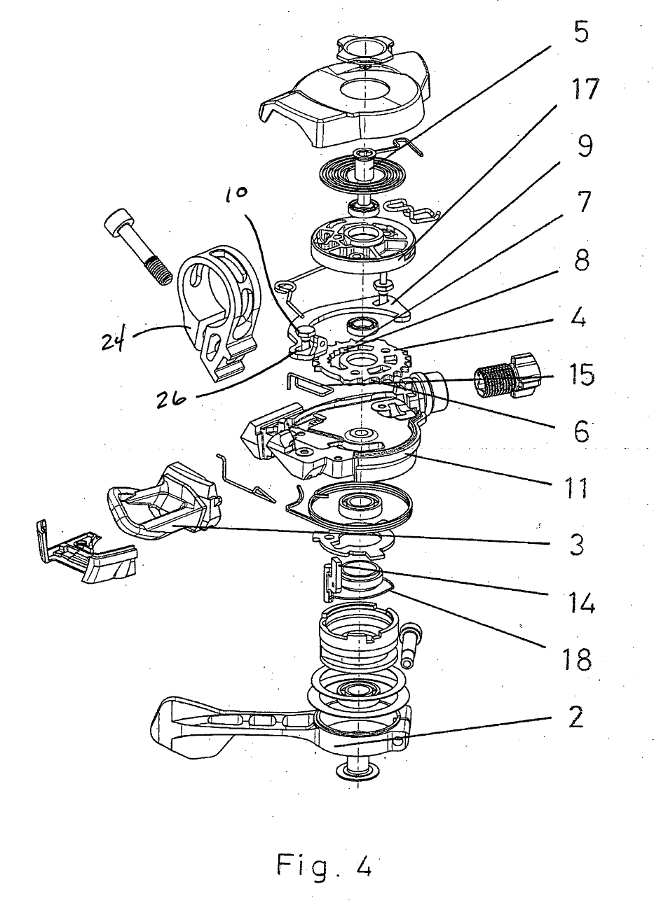

FIG. 4 shows an exploded depiction of the trigger shifter in order to illustrate the components. The functional components such as the cable coil 17, disk element 4 [sic; should be 9], the shifter housing 11, and the takeup lever 2 are arranged and/or pivot around the axis 5. The sliding element 9 [sic; should be 4] with the retaining and catch pawls, the disk element 4 with the retaining tooth set 6 and catch tooth set 7 on its circumference, as well as the transport tooth set 8 located on the inside, the shackle spring 15, and the takeup pawl 14 are the most essential components to controlling the shifting process next to the takeup lever 2 and release lever 3. These components, with the exception of the disk element 4 and the cable coil 17, are directly or indirectly returned to their original position using the initial spring tension after the shifting process has been completed. The takeup pawl 14, which is subjected to initial tension by a pawl spring 18, is guided either directly on the takeup lever 2 or by components that are non-rotationally connected to the takeup lever 2.

### LIST OF REFERENCE NUMBERS

1 Trigger shifter
2 Takeup lever
3 Release lever
4 Disk element
5 Axis
6 Retaining tooth set
7 Catch tooth set
8 Transport tooth set
9 Sliding element
10 Guide element
11 Shifter housing
12 Retaining pawl
13 Catch pawl
14 Takeup pawl
15 Shackle spring
16 Shackle
17 Cable coil
18 Pawl spring

1. Shifting mechanism for a stepping shifter (1) for bicycles having a takeup mechanism for pulling in a cable pull, with a takeup pawl (14) that engages with a transport tooth set (8);
having a gripping and releasing mechanism for the gradual release of the cable pull, with at least one release element that returns to its original position after the release process has been completed as well as one retaining pawl (12) and one catch pawl (13) that engage with a retaining tooth set (6) and a catch tooth set (7), respectively,
characterized in that,
upon the return of the release element to its original position, the takeup pawl (14) engages in the transport tooth set (8) and, during the release process, is removed from the engagement by the release element, either directly or by way of a connecting link.

2. Shifting mechanism for a stepping shifter (1) according to claim 1,
characterized in that
the takeup pawl (14) is mounted on the takeup element, preferably a takeup lever (2), and is prestressed in the closing direction by a pawl spring (18).

3. Shifting mechanism for a stepping shifter (1) according to claim 1,
characterized in that
the stop position of the takeup element is selected in such a way that the takeup pawl (14) is engaged in the transport tooth set (8) when the takeup element is in its original position and is positioned directly in front of, or is slightly touching, a transport tooth.

4. Shifting mechanism for a stepping shifter (1) according to claim 1,
characterized in that
the connecting link is embodied as a spring that is inserted or rotationally mounted in the shifter housing (11) and transfers the motion of the release element, preferably a release lever (3), or the sliding element (9) onto the takeup pawl (14).

5. Shifting mechanism for a stepping shifter (1) according to claim 1,
characterized in that
the connecting link is preferably embodied as a shackle spring (15), with one end of the shackle spring (15) being supported on the shifter housing (11) while the other end rests against the sliding element (9) or the release element and the shackle moves the takeup pawl (14) out of the region of the transport tooth set (8) when the release element is activated.

6. Shifting mechanism for a stepping shifter (1) according to claims 4 and 5,
characterized in that
the takeup pawl (14) is moved out of the transport tooth region by means of a spring or the shackle spring (15) before the retaining pawl (12) on the sliding element (9) releases the retaining tooth set (6) and thus allows the cable pull to be unwound.

7. Shifting mechanism for a stepping shifter (1) according to claim 6,
characterized in that,
after the release process has occurred, the retaining pawl (12) again comes into engagement with the retaining tooth set (6) before the takeup pawl (14) is returned to its original position in the engagement region of the transport tooth set (8) by the initial tension of the pawl spring (18).

8. Shifting mechanism for a stepping shifter (1) according to claim 5,
characterized in that
the shackle spring (15) aids the return of the sliding element (9) or even functions as its sole return spring.
